(19) United States
(12) Patent Application Publication
(10) Pub. No.: US 2026/0295424 A1
(43) Pub. Date: Oct. 1, 2026

(54) PROGRAM, TERMINAL, AND GAME METHOD

(71) Applicant: Bandai Co., Ltd., Tokyo (JP)

(72) Inventors: Kohei GOTO, Tokyo (JP); Takuya IMAMURA, Tokyo (JP)

(21) Appl. No.: 19/490,072

(22) PCT Filed: Jun. 24, 2024
(86) PCT No.: PCT/JP2024/022913

§ 371 Date: Dec. 4, 2025

(30) Foreign Application Priority Data
Jun. 5, 2023 (JP) 2023-092791

(51) Int. Cl. A63F 13/63; A63F 13/58; A63F 13/822

(52) U.S. Cl. CPC A63F 13/63; A63F 13/58; A63F 13/822

(57) ABSTRACT

A game that improves amusement is provided.

There is provided a program causing a computer to function as: game element presentation means for presenting a first-type game element and a second-type game element, the first-type game element being associated with a first-type character and including a plurality of pieces of group identification information which are visually identifiable, and the second-type game element being associated with a second-type character and including any one piece of group identification information which is visually identifiable and is included in the plurality of pieces of group identification information; and deck construction means for constructing a deck from the second-type game elements including any piece of group identification information included in the plurality of pieces of group identification information of the first-type game element.

### CROSS REFERENCE TO RELATED APPLICATIONS

This application is a national stage application, filed under 35 U.S.C. § 371, of International Application No. PCT/JP2024/022913, filed Jun. 24, 2024, which claims priority to Japan Application No. 2023-092791, filed Jun. 5, 2023, the contents of both of which are hereby incorporated by reference in their entirety.

### BACKGROUND

### Technical Field

The present disclosure relates to a program, a terminal, and a game method.

### Background Art

Among competitive card games, there is a game where a plurality of types of cards arranged on a playmat are combined to activate a special effect (Japanese Patent Application Publication 2006-247178 A, for example).

### BRIEF SUMMARY

In such a game, a storyline is important. Then, a highly versatile game that maintains a storyline can ultimately improve amusement of the game.

Therefore, an object of an aspect of the present disclosure is to provide a program, a terminal, and a game method for improving amusement of a game.

According to an aspect of the present disclosure, there is provided a program causing a computer to function as: game element presentation means for presenting a first-type game element and a second-type game element, the first-type game element being associated with a first-type character and including a plurality of pieces of group identification information which are visually identifiable, and the second-type game element being associated with a second-type character and including any one piece of group identification information which is visually identifiable and is included in the plurality of pieces of group identification information; and deck construction means for constructing a deck from the second-type game elements including any piece of group identification information included in the plurality of pieces of group identification information of the first-type game element.

According to another aspect of the present disclosure, there is provided a terminal including: game element presentation means for presenting a first-type game element and a second-type game element, the first-type game element being associated with a first-type character and including a plurality of pieces of group identification information which are visually identifiable, and the second-type game element being associated with a second-type character and including any one piece of group identification information which is visually identifiable and is included in the plurality of pieces of group identification information; and deck construction means for constructing a deck from the second-type game elements including any piece of group identification information included in the plurality of pieces of group identification information of the first-type game element.

According to still another aspect of the present disclosure, there is provided a game execution method causing a computer to execute: presenting a first-type game element that is associated with a first-type character and includes a plurality of pieces of group identification information which are visually identifiable; presenting a second-type game element that is associated with a second-type character and includes any one piece of group identification information which is visually identifiable and is included in the plurality of pieces of group identification information; and constructing a deck from the second-type game elements including any piece of group identification information included in the plurality of pieces of group identification information of the first-type game element.

According to an aspect of the present disclosure, it is possible to provide a game that improves amusement.

### BRIEF DESCRIPTION OF THE FIGURES

FIG. 1 is a schematic diagram of a play field 2 according to the present embodiment.

FIG. 2 is a diagram illustrating an example of a back face of a game card 1.

FIG. 3 is a diagram illustrating an example of a front face of a cost card 10.

FIG. 4 is a diagram illustrating an example of a front face of a character card 20.

FIG. 5 is a diagram illustrating an example of a front face of a leader card 30.

FIG. 6 is a diagram illustrating an example of a front face of a multi-leader card 40.

FIG. 7 is a diagram illustrating an example of a front face of a stage card 50.

FIG. 8 is a diagram illustrating an example of a front face of an event card 60.

FIG. 9 is a diagram illustrating an example of deck construction.

FIG. 10 is a diagram illustrating an overall configuration example of a game system according to the present embodiment.

FIG. 11 is a diagram illustrating an apparatus configuration example of a smartphone that is an example of a player terminal 3.

FIG. 12 is a block diagram illustrating a functional configuration example of the player terminal 3.

FIG. 13 is an example of a game card database 140.

FIG. 14 is a diagram illustrating an example of a deck database 141.

FIG. 15 is a block diagram illustrating a functional configuration example of a game server 4.

FIG. 16 is an operation flowchart of deck construction processing.

FIG. 17 is an example of a deck construction screen displayed by a deck construction unit 124.

FIG. 18 is a diagram illustrating an example of display of a game card including selected group identification information (color information 27).

FIG. 19 is a diagram illustrating an example of display of a game card including selected group identification information (color information 27).

FIG. 20 is a diagram illustrating an example of display of a game card compatible with a multi-leader card.

FIG. 21 is an operation flowchart of play field presentation processing.

FIG. 22 is a diagram illustrating an example of a screen for selecting a leader card and a deck.

FIG. 23 is a diagram illustrating an example of a play field 2 displayed on the player terminal 3.

FIG. 24 is a diagram illustrating an example of a play field 2 displayed on the player terminal 3.

FIG. 25 is a flowchart of card arrangement processing.

FIG. 26 is a diagram for explaining an operation of arranging a card.

FIG. 27 is a flowchart of attack value increasing processing.

FIG. 28 is a diagram for explaining attack value increasing processing.

### DETAILED DESCRIPTION OF VARIOUS EMBODIMENTS

An embodiment of the present disclosure will be described.

First, an outline of a game in the present embodiment will be described.

A game according to the present embodiment is a battle game in which a battle with an opponent is performed by arranging game elements onto a play field. The game element is associated with a character, and a plurality of regions (areas) in which the game elements are arranged are provided on the play field. A player arranges the game elements on any region (area) of the play field, and plays the game using abilities of the characters associated with the game elements.

The game elements include a first-type game element, a second-type game element, a third-type game element, and a fourth-type game element. The first-type game element, the second-type game element, and the third-type game element are associated with specific characters. On the other hand, the fourth-type game element is not associated with a specific character. Here, the character is a person, an animal, an event, or the like.

The first-type game element, the second-type game element, and the third-type game element include identification information that can be visually identified. This identification information is group identification information for identifying a group to which a character associated with each element belongs. Here, the group is a team to which a character belongs, an episode in which a character appears, or the like. The group identification information may be any type of information as long as the group identification information can identify the group. Examples of the group identification information include text information of a group name, color information for identifying the group, and the like.

The first-type game element and the third-type game element are associated with a first-type character. The first-type character is a leader of a group, and is a centerpiece character of the group. A difference between the first-type game element and the third-type game element is the number of pieces of included group identification information. The first-type game element includes pieces of group identification information of all the groups existing in the game. On the other hand, the third-type game element includes one or two pieces of group identification information among pieces of group identification information of all the groups existing in the game.

The second-type game element is associated with a second-type character. The second-type character is a character belonging to a group, and is a character that becomes an ally of the leader of the group or a character that activates an event. The second-type game element includes group identification information of one of the groups existing in the game.

In addition, the second-type game element is a constituent element of a collection that includes a plurality of second-type game elements used in the battle game and is called a deck. However, the second-type game element that can be a constituent element of the deck is limited to the second-type game element including the same group identification information as the group identification information included in the first-type game element or the third-type game element used in the game. That is, the second-type game element including the same group identification information as the group identification information included in the first-type game element or the third-type game element used in the game can be a constituent element of the deck used in the game. In this way, only the allies of the first-type character that is a leader and the second-type character appearing in the similar episode will appear in the game, and thus, a storyline can be given to the game.

The fourth-type game element is not associated with a specific character, and serves as a payment for the cost of bringing the second-type game element into the game place. In addition, the fourth-type game element does not include group identification information for identifying a group.

In addition, the first-type game element, the second-type game element, the third-type game element, and the fourth-type game element are associated with virtual articles.

One example of the virtual article is, for example, a virtual game card displayed on a computer. In the game according to the present embodiment, the first-type game element, the second-type game element, the third-type game element, and the fourth-type game element will be described as a virtual game card associated with a character of which the action is controlled based on an operation of a player (including a non-player operated by a computer), and a picture of the corresponding character (an image showing an appearance of the character) will be attached to the game card. Further, the game card for the purpose of specifying the game element of the game to be executed is not limited to the game card configured to be able to specify the game element such as a character, and it goes without saying that the game card may specify other game elements such as an item and an effect to be activated (for example, the fourth-type game element). Note that the article is not limited to the game card, and is not limited to the game card as long as the article is configured to be able to specify the game element associated with the article. The virtual article may be, for example, a shaped object such as a figurine with an appearance of a character.

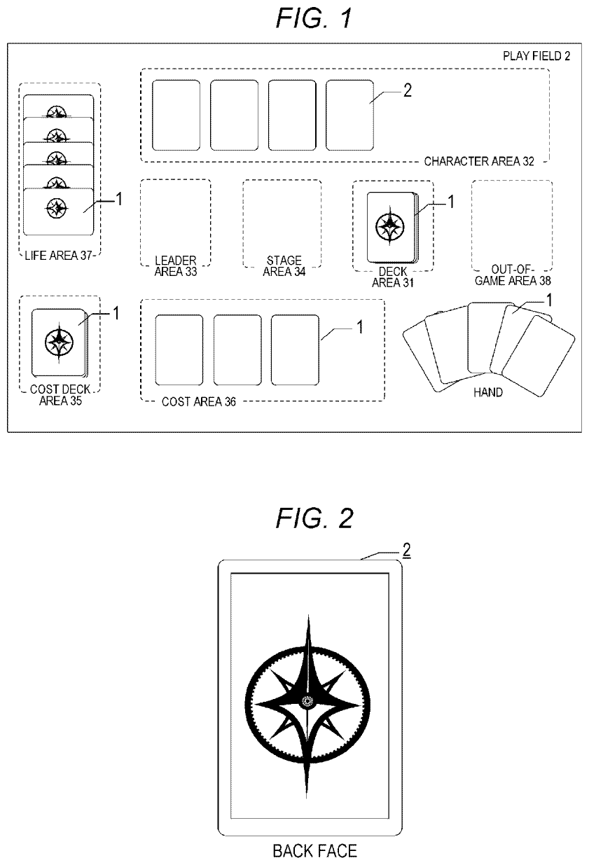

FIG. 1 is a schematic diagram for explaining a game according to the present embodiment. As illustrated in FIG. 1, the game includes game cards 1 and a play field 2.

The game card 1 corresponds to the game element described above, and is a card held by a player. The player can acquire the game card 1 by purchase, exchange of the cards between players, distribution to players who have met certain conditions, and the like.

The game card 1 has a front face and a back face. Any one of the same picture, text, and the like is drawn on the back face of the game card 1, regardless of the card type. That is, the front face of the game card 1 (the face that allows recognition of the card type of the game card 1) cannot be identified from the back face of the game card 1. FIG. 2 is an example of the back face of the game card 1.

The game card 1 has a normal orientation, and the normal orientation is a state in which a user can read the content described on the front face of the game card 1 as it is. In the following description, a state in which the game card 1 is arranged in the normal orientation will be referred to as an active state. A lateral state in which the arrangement state of the game card 1 is rotated 90 degrees from the normal orientation will be referred to as a rest state. Note that a predetermined orientation may be set beforehand as the active state, and a case where the orientation of the game card is changed from the predetermined orientation may be set as the rest state.

The front faces of the game cards 1 are prepared in a plurality of types according to the present embodiment. The front faces of the game cards 1 vary depending on the types of information described thereon. In the following description, a cost card 10 (corresponding to the fourth-type game element) will be described as an example of the game card 1 not including color information which is the group identification information. In addition, as the game card 1 including color information, a character card 20 (corresponding to the second-type game element), a normal leader card 30 (corresponding to the third-type game element), a multi-leader card 40 (corresponding to the first-type game element), a stage card 50 (corresponding to the second-type game element), and an event card 60 (corresponding to the second-type game element) will be described as an example. However, as long as there are cards not including color information and cards including color information, any number of types of game cards 1 may be provided.

The color information is color information for identifying a group to which a character associated with the character card 20, the leader card 30, the multi-leader card 40, the stage card 50, and the event card 60 belongs. The color information is arranged at the same position on the character card 20, the leader card 30, the multi-leader card 40, the stage card 50, and the event card 60. In the present embodiment, a total of six groups of characters are set, and color information of any one of red, green, blue, purple, black, and yellow is assigned to each group. Then, an example in which one piece of color information is assigned to each triangular region obtained by dividing a hexagon, which is an arrangement portion of color information, into six equal parts will be described. Note that the number of groups or the color indicating each group can be changed as needed.

It means that characters associated with the character card 20, the leader card 30, the multi-leader card 40, the stage card 50, and the event card 60, each of which includes the same color information, belong to the same group. The groups are teams (allies), episodes, or the like. Then, as will be described later, the deck can be constructed from the character card 20, the stage card 50, and the event card 60 each of which includes the same color information as the color information of the leader card 30 and the multi-leader card 40. Thereby, the game can have a storyline.

### Cost Card 10

The cost card 10 corresponds to the fourth-type game element.

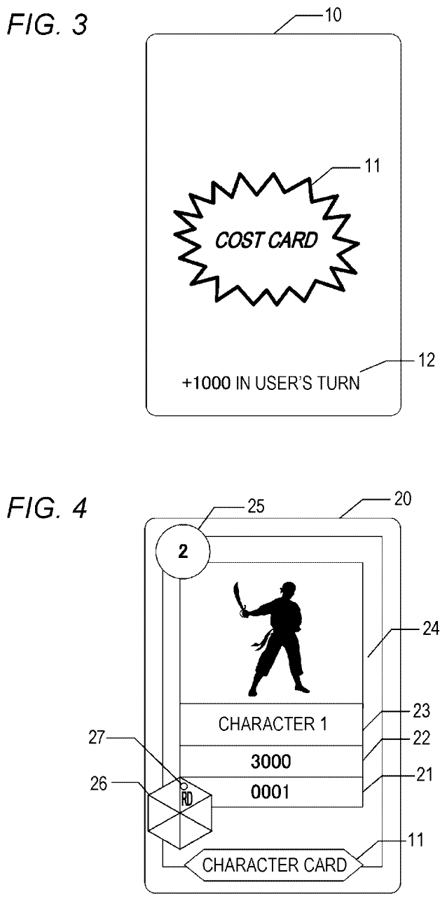

FIG. 3 is a diagram illustrating an example of a front face of the cost card. The cost card 10 is a card that performs a first function and a second function. The first function is a function that implements a cost element for arranging the character card 20, the stage card 50, and the event card 60 onto the play field 2 from the user's hand. In this card game, the game cards 1 that can be arranged from the hand onto the play field 2 are limited, depending on the number of cost cards 10 arranged onto the play field 2. That is, in order to arrange the game cards 1 from the hand onto the play field 2, the number of cost cards 10 matching the conditions of the game cards 1 is required. Therefore, the cost card 10 serves as an element of the conditions for arranging the game card 1 from the hand onto the play field 2, and this is the first function of the cost card 10.

The second function is a function of increasing attack values of the character card 20, the leader card 30, or the multi-leader card 40 combined with the cost card 10. In this card game, the cost card 10 arranged onto the play field 2 can be used in combination with the character card 20, the leader card 30, or the multi-leader card 40. In a case where the user combines the cost card 10 with the character card 20, the leader card 30, or the multi-leader card 40 in his/her turn, the attack value of the combined character card 20, the leader card 30, or the multi-leader card 40 is increased.

As illustrated in FIG. 3, the cost card 10 includes card type information 11 that is information indicating that the card is a cost card, and second function information 12 that is information related to the second function of the cost card 10. In the example illustrated in FIG. 3, “+1000 in user's turn” is described as the second function information 12. In this example, it means that the attack value of the character card 20, the leader card 30, or the multi-leader card 40 is increased by “1000” by combining the cost card 10 with the character card 20, the leader card 30, or the multi-leader card 40.

### Character Card 20

The character card 20 corresponds to the second-type game element.

FIG. 4 is a diagram illustrating an example of the front face of the character card 20. The character card 20 includes card type information 11, card identification information 21, power information 22, a character name 23, a character image 24, cost information 25, a color information arrangement portion 26, and color information 27 described thereon.

The card type information 11 is information indicating the type of the card, and is information indicating that the card is a character card in the case of the character card 20. The card identification information 21 is information for uniquely identifying the game card 1, and is a card number or the like. The power information 22 is numerical value information indicating an attack value against the game card 1 of the opponent. The character name 23 is a character name of the character associated with the character card 20. The character image 24 is a picture of the character associated with the game card.

The cost information 25 is a numerical value or the like of a required cost that is required for the user to arrange the character card 20 onto the play field 2 from the hand. In the example in FIG. 4, the cost information 25 is “2”, which indicates that two cost cards 10 are required to arrange the character card 20 onto the play field 2.

The color information arrangement portion 26 is a portion in which color information 27 corresponding to a group to which a character associated with the character card 20 belongs is arranged. In the present embodiment, since the groups of the characters are six groups in total, the color information arrangement portion 26 has a hexagonal shape, and one piece of color information 27 is assigned to each triangular shape obtained by dividing the hexagonal shape into six equal parts. Then, a color indicated by the color information 27 indicates a group to which the character belongs. The character card 20 includes only one piece of color information 27. The example of the character card 20 in FIG. 4 illustrates an example in which the color information 27 is “red”, and indicates that a character 1 of the character card 20 belongs to a group “red”. Note that, in the example of FIG. 4, the color information 27 is indicated by text, but the color information 27 may be indicated by coloring the assigned triangular shape with the color of the group. For example, the triangular shape of the color information 27 in FIG. 4 may be colored with “red”.

### Leader Card 30

The leader card 30 corresponds to the third-type game element.

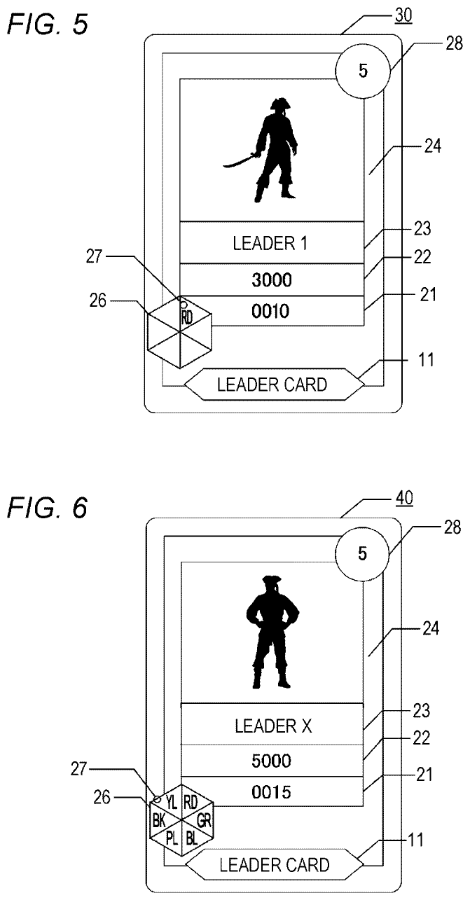

FIG. 5 is a diagram illustrating an example of the front face of the leader card 30. The leader card 30 includes card type information 11, card identification information 21, power information 22, a character name 23, a character image 24, a color information arrangement portion 26, color information 27, and life information 28 described thereon.

The card type information 11 is information or the like indicating the type of the card and, in the case of the character card 30, indicating that the card is a leader card. The card identification information 21 is information for uniquely identifying the game card 1, and is a card number or the like. The power information 22 is numerical value information indicating an attack value against the game card 1 of the opponent. The character name 23 is a character name of the character associated with the leader card 30. The character image 24 is a picture of the character associated with the leader card 30. Note that the character associated with the leader card 30 is a character as a leader of the group specified by the color information 27.

The color information arrangement portion 26 is a portion in which, similar to the character card 20, color information 27 corresponding to a group to which a character associated with the leader card 30 belongs is arranged. In the present embodiment, since the groups of the characters are six groups in total, the color information arrangement portion 26 has a hexagonal shape, and one piece of color information 27 is assigned to each triangular shape obtained by dividing the hexagonal shape into six equal parts. Then, a color indicated by the color information 27 indicates a group to which the character belongs. The leader card 30 includes only one or two pieces of color information 27. The example of the leader card 30 in FIG. 5 illustrates an example in which the color information 27 is “red”, and indicates that a leader 1 of the leader card 30 belongs to a group “red”. Note that, in the example of FIG. 5, the color information 27 is indicated by text, but the color information 27 may be indicated by coloring the assigned triangular shape with the color of the group. For example, the triangular shape of the color information 27 in FIG. 5 may be colored with “red”. Note that the number of pieces of color information 27 of the leader card 30 is one or two, but may be smaller than the total number of the groups.

Note that the color information 27 of the leader card 30 serves as a guideline when the deck is constructed. In a case where the leader card 30 is used in a game, a deck to be used in the game can be constructed from the character card 20, the stage card 50, and the event card 60 each of which includes the same color information 27 as the color information 27 of the leader card 30. For example, in a case where the leader card 30 including the color information 27 of “red” is used in a game, a deck to be used in the game can be constructed from the character card 20, the stage card 50, and the event card 60 each of which includes the color information 27 of “red”.

The life information 28 indicates the number of character cards 20 that can be arranged in a life area (described later) on the play field 2 at the beginning of the game.

### Multi-Leader Card 40

The multi-leader card 40 corresponds to the first-type game element.

FIG. 6 is a diagram illustrating an example of the front face of the multi-leader card 40. The multi-leader card 40 includes card type information 11, card identification information 21, power information 22, a character name 23, a character image 24, a color information arrangement portion 26, color information 27, and life information 28 described thereon.

The card type information 11 is information or the like indicating the type of the card and, in the case of the multi-leader card 40, indicating that the card is a leader card.

The card identification information 21 is information for uniquely identifying the game card 1, and is a card number or the like. The power information 22 is numerical value information indicating an attack value against the game card 1 of the opponent. The character name 23 is a character name of the character associated with the multi-leader card 40. The character image 24 is a picture of the character associated with the multi-leader card 40. Note that the character associated with the multi-leader card 40 is a character as a leader of the group specified by the color information 27.

The color information arrangement portion 26 is a portion in which, similar to the character card 20, color information 27 corresponding to a group to which a character associated with the multi-leader card 40 belongs is arranged.

The multi-leader card 40 is different from the leader card 30 in that, in the leader card 30, pieces of color information 27 of some (one or two) groups of all groups are arranged in the color information arrangement portion 26, whereas in the multi-leader card 40, pieces of color information 27 (red, green, blue, purple, black, and yellow) of all groups are arranged in the color information arrangement portion 26. Thereby, in a case where the multi-leader card 40 is used, a deck can be constructed by the character card 20, the stage card 50, and the event card 60 which include pieces of color information 27 (red, green, blue, purple, black, and yellow) of all the groups. That is, one deck (mixed color deck) can be constructed by the character card 20, the stage card 50, and the event card 60 of which the pieces of color information 27 are different from each other.

One of the reasons for providing the multi-leader card 40 is for a user who owns only a small number of game cards 1. In this game, as described above, the deck can be constructed only from the character card 20, the stage card 50, and the event card 60 each of which includes the same color information 27 as the color information 27 of the leader card 30 to be used. However, in a case where a user owns only a small number of game cards 1, it is predicted that the user will not be able to collect the number of the character cards 20, the stage cards 50, and the event cards 60 each of which includes the same color information 27 as the leader card 30 and which are required to build a deck (for example, 50 cards). Leaving such a case as it is is harsh on the user. Therefore, such a problem is solved by preparing the multi-leader card 40 including all the pieces of color information 27.

Another reason is that, since this game places a high value on the storyline, a character such as the character card 20 belongs to one of the groups, but a specific character such as the character card 20 does not necessarily belong to only one group. In such a case, the character card 20 or the like can include a plurality of pieces of color information 27. However, there may be a plurality of types of character cards 20 or the like including different color information 27 for the same character, and the storyline is weakened and becomes complicated. Therefore, such a problem is solved by preparing the multi-leader card 40 including all the pieces of color information 27 such that a deck can be constructed from the character card 20, the stage card 50, and the event card 60 associated with the characters belonging to the plurality of groups.

Examples of the event described above include an event in which a deck is constructed only with the game cards 1 included in a package sold for a limited period and a game is played. As described above, the game cards 1 including different color information 27 are sold together in the package sold for a limited period. Even in a case where all the game cards 1 included in the package do not include the same color information 27, the user can construct a deck only with the game cards 1 included in the package by using the multi-leader card 40. Note that, for the multi-leader card 40, there are a method of distributing the multi-leader card 40 to the user participating in the event such that the user can acquire the multi-leader card, a method of including the multi-leader card 40 in all the packages, and a method of clearly indicating that the multi-leader card 40 is included in the packages.

In addition, in the game cards 1 included in the package sold for a limited period, even after the event or the like is ended, the color information 27 is a single piece of information that can be used under a normal rule, and the game cards 1 included in the package are not wasted for the user.

The life information 28 indicates the number of character cards 20 that can be arranged in a life area (described later) on the play field 2 at the beginning of the game.

### Stage Card 50

The stage card 50 corresponds to the second-type game element.

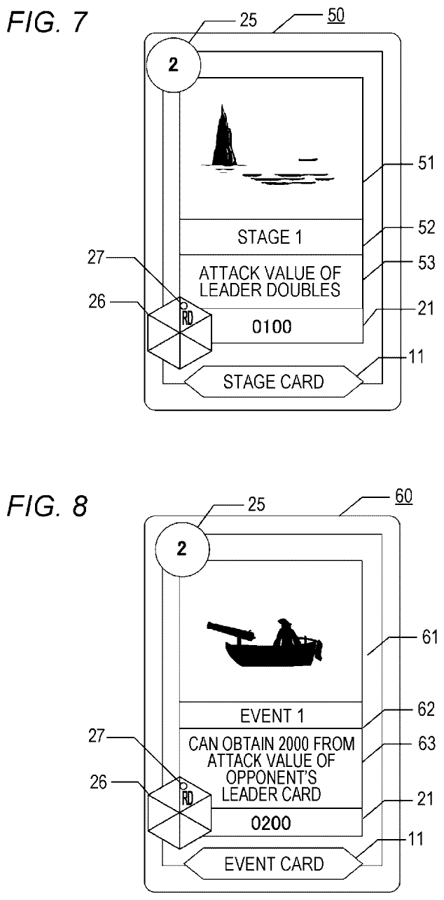

FIG. 7 is a diagram for explaining an example of the front face of the stage card 50. In a case where the stage card 50 is arranged onto the play field 2 (or is made to appear on the place), the effect described on the stage card 50 is applied during the game.

The stage card 50 includes card type information 11, card identification information 21, cost information 25, a color information arrangement portion 26, color information 27, a stage image 51, a stage name 52, and stage effect information 53 described thereon.

The card type information 11 is information or the like indicating the type of the card and, in the case of the stage card 50, indicating that the card is a stage card. The card identification information 21 is information for uniquely identifying the game card 1, and is a card number or the like.

The cost information 25 is information of the cost required for the user to arrange the stage card 50 onto the play field 2 from the hand, and is a numerical value or the like of the required cost. In the example in FIG. 7, the cost information 25 is “2”, which indicates that two cost cards 10 are required to arrange the stage card 50 onto the play field 2.

The color information arrangement portion 26 is a portion in which color information 27 corresponding to a group to which a character associated with the stage card 50 belongs is arranged. As described above, in the present embodiment, since the groups of the characters are six groups in total, the color information arrangement portion 26 has a hexagonal shape, and one piece of color information 27 is assigned to each triangular shape obtained by dividing the hexagonal shape into six equal parts. Then, a color indicated by the color information 27 indicates a group to which the character belongs. The stage card 50 includes only one piece of color information 27. The example of the stage card 50 in FIG. 7 illustrates an example in which the color information 27 is “red”, and indicates that a character of the stage card 50 belongs to a group “red”.

The stage name 52 is a name of a stage (character) associated with the stage card 50. The stage image 51 is a picture of a stage (character). Note that the stage image 51 most preferably is a picture from which at least part of the effect to be exhibited by the stage card 50 can be intuitively understood. With this arrangement, even in a case where the players do not memorize the effect of each stage card 50, a part of the effect can be intuitively understood. Thus, there is no possibility that the progress of the game will be delayed in understanding the effect to be exhibited by the card, and the amusement of the game will not be lost.

The stage effect information 53 is information related to an effect when the stage card 50 is arranged onto the play field 2.

### Event Card 60

The event card 60 corresponds to the second-type game element.

FIG. 8 is a diagram for explaining an example of the front face of the event card 60. In a case where the event card 60 is arranged onto the play field 2 (or is made to appear on the place), an effect of an event described on the event card 60 is applied during the game.

The event card 60 includes card type information 11, card identification information 21, cost information 25, a color information arrangement portion 26, color information 27, an event image 61, an event name 62, and event effect information 63 described thereon.

The card type information 11 is information or the like indicating the type of the card and, in the case of the event card 60, indicating that the card is an event card. The card identification information 21 is information for uniquely identifying the game card 1, and is a card number or the like.

The cost information 25 is information of the cost required for the user to arrange the event card 60 onto the play field 2 from the hand, and indicates a numerical value of the required cost. In the example in FIG. 8, the cost information 25 is “2”, which indicates that two cost cards 10 are required to arrange the event card 60 onto the play field 2.

The color information arrangement portion 26 is a portion in which color information 27 corresponding to a group to which an event (character) associated with the event card 60 belongs is arranged. As described above, in the present embodiment, since the groups of the characters are six groups in total, the color information arrangement portion 26 has a hexagonal shape, and one piece of color information 27 is assigned to each triangular shape obtained by dividing the hexagonal shape into six equal parts. Then, a color indicated by the color information 27 indicates a group to which the character belongs. The event card 60 includes only one piece of color information 27. The example of the event card 60 in FIG. 8 illustrates an example in which the color information 27 is “red”, and indicates that a character of the event card 60 belongs to a group “red”.

The event name 62 is a name of an event (character) associated with the event card 60. The event image 61 is a picture of an event (character). Note that the event image 61 most preferably includes a picture from which at least part of the effect to be exhibited by the event card 60 can be intuitively understood. With this arrangement, even in a case where the players do not memorize the effect of each event card 60, a part of the effect can be intuitively understood. Thus, there is no possibility that the progress of the game will be delayed to understand the effect to be exhibited by the card, and the amusement of the game will not be lost.

The event effect information 63 is information related to an effect when the event card 60 is arranged onto the play field 2.

Although the card type information 11 indicating the type of each game card 1 is provided on each game card 1 described above, the type of each game card 1 may be identified by a basic color of the card. In particular, it is preferable that the leader card 30 and the multi-leader card 40 corresponding to the first-type game element are different in color from the character card 20, the stage card 50, and the event card 60 corresponding to the second-type game element. This is because the leader card 30 and the multi-leader card 40 corresponding to the first-type game element are not elements that construct a deck, and the character card 20, the stage card 50, and the event card 60 are elements that construct a deck. Therefore, in a case where the character card 20, the stage card 50, and the event card 60 have the same color, the colors of the leader card 30 and the multi-leader card 40 may be different from the colors of the character card 20, the stage card 50, and the event card 60. Further, the colors of the leader card 30 and the multi-leader card 40 may also be different from each other.

### Play Field 2

Next, the play field 2 will be described with reference to FIG. 1. In the example illustrated in FIG. 1, an upper portion of the play field 2 is located on the opponent side.

As illustrated in FIG. 1, the play field 2 is formed in a quadrangular shape, for example, a rectangular shape.

A plurality of areas (regions) are formed on the play field 2. The plurality of areas indicate places where the player arranges the game cards 1. In the following description, a case where there are eight areas including a deck area 31, a character area 32, a leader area 33, a stage area 34, a cost deck area 35, a cost area 36, a life area 37, and an out-of-game area 38 will be described as an example. Note that these eight areas are only required to have different roles, and the names of the areas may be any kinds of names that the players can understand when playing.

As illustrated in FIG. 1, the character area 32 is formed along an end portion (corresponding to a first end portion) of the play field 2 on the opponent side. As will be described later, since the character area 32 is an area in which the character cards 20 which are the focus of the battle are arranged, the character area 32 is arranged in the vicinity of the opponent side such that the opponent can easily visually recognize the character area 32. The cost area 36 is formed along an end portion (corresponding to the second end portion) of the play field 2 on the user side opposite to the opponent side. As will be described later, since the cost area 36 is an area in which the cost card 10 that needs to be operated by the user is arranged, the cost area 36 is arranged in the vicinity of the user side. The deck area 31, the leader area 33, the stage area 34, and the out-of-game area 38 are formed between the character area 32 and the cost area 36. The life area 37 and the cost deck area 35 are formed along an end portion (corresponding to the third end portion) of the play field 2 sandwiched between the end portion on the opponent side and the end portion on the user side. In the example illustrated in FIG. 1, the life area 37 and the cost deck area 35 are formed along the left end portion of the play field 2.

The deck area 31 is a region in which a deck constructed by the user is stacked in such a manner that the game cards 1 cannot be identified. That is, in the deck area 31, the game cards 1 having the front faces facing downward are arranged in an overlapping manner.

The character area 32 is an area in which the cost card 10 and the character card 20 can be arranged. In a case where the value of the cost information 25 is equal to or smaller than the total number of the cost cards 10 arranged in the cost area 36, a character card 20 can be arranged from the hand of the user. The cost card 10 to be arranged in the character area 32 is arranged by being moved from the cost area 36, but the cost card 10 arranged in the cost area 36 in an active state can be moved. The cost card 10 to be arranged in the character area 32 is arranged under a character card 20 in an overlapping manner such that the cost card 10 is partially hidden. In the following description, arranging the cost card 10 under the character card 20 in an overlapping manner will be referred to as “application of power to the character card 20”. By application of power to the character card 20, the attack value of the character card 20 is increased. In the following description, for ease of explanation, a case where the attack value of the character card 20 is increased by “1000” every time one cost card 10 is stacked will be described as an example.

The character card 20 arranged in the character area 32 can attack any of the character card 20 arranged in the character area 32 of the opponent, and the leader card 30 or the multi-leader card 40 arranged in the leader area 33 of the opponent.

The leader area 33 is an area in which the leader card 30 or the multi-leader card 40 and the cost card 10 are arranged. The leader card 30 or the multi-leader card 40 in the leader area 33 is arranged at the beginning of the game. The cost card 10 to be arranged in the leader area 33 is arranged by being moved from the cost area 36, but the cost card 10 arranged in the cost area 36 in an active state can be moved. The cost card to be arranged in the leader area 33 is arranged under the leader card 30 or the multi-leader card 40 in an overlapping manner such that the cost card is partially hidden. In the following description, arranging the cost card 10 under the leader card 30 or the multi-leader card 40 in an overlapping manner will be referred to as “application of power to the leader card 30 or the multi-leader card 40”. By application of power, the attack value of the leader card 30 or the multi-leader card 40 is increased.

In the following description, for ease of explanation, a case where the attack value of the leader card 30 or the multi-leader card 40 is increased by “1000” every time one cost card 10 is stacked will be described as an example. In addition, similarly to the application of power to the character card 20, a case where the attack value is increased by “1000” when power is applied to the leader card 30 or the multi-leader card 40 every time one cost card 10 is stacked will be described as an example. However, the increase value may be different between the application of power to the character card 20 and the application of power to the leader card 30 or the multi-leader card 40.

The stage area 34 is an area in which a stage card 50 can be arranged. In a case where the value of the cost information 25 is equal to or smaller than the total number of the cost cards 10 arranged in the cost area 36, the stage card 50 can be arranged from the hand of the user.

The cost deck area 35 is an area in which the cost card 10 can be arranged. At the beginning of the game, a predetermined number of cost cards 10 are stacked in an overlapping manner in the cost deck area 35. In the following description, for ease of explanation, it is assumed that ten cost cards 10 are stacked in the cost deck area at the beginning of the game.

The cost area 36 is an area in which a predetermined number of cost cards 10 are arranged from the cost deck area 35. In the following description, a case where two cost cards 10 are drawn from the cost deck area 35 and are arranged will be described as an example.

The life area 37 is an area in which the game cards including at least one of the character card 20, the stage card 50, or the event card 60 are arranged, and the number of the game cards is equal to the numerical value described in the life information 27 of the leader card 30 or the multi-leader card 40 arranged in the leader area 33.

The out-of-game area 38 is an area in which used game cards 1 are arranged.

The outline of the game cards 1 and the play field 2 to be used in the game according to the present embodiment has been described above.

### Preparation of Game

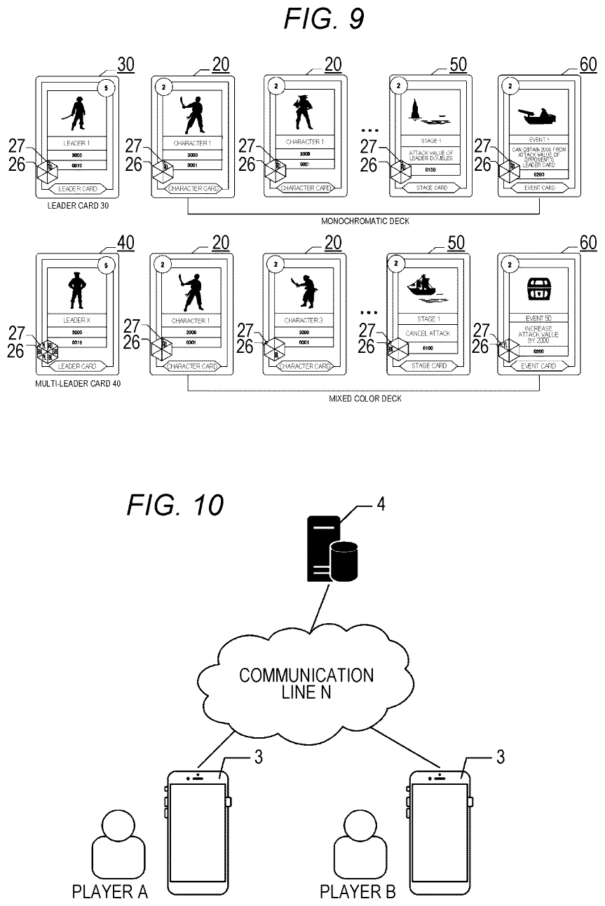

First, the deck to be used by the user will be described. FIG. 9 is a diagram for explaining the deck. As described above, the deck can be constructed from the character card 20, the stage card 50, and the event card 60 each of which includes the same color information 27 as the leader card 30 to be used. For example, as illustrated in FIG. 9, in a case where the leader card to be used is the leader card 30 including the single color information 27 of “red”, the deck can be constructed from the character card 20, the stage card 50, and the event card 60 each of which includes the color information 27 of “red”.

However, characters other than the leader of the group may also fight together between different groups, and it may be desirable to realize such a situation in the game.

As a method for solving this problem, it is conceivable to provide a plurality of pieces of color information 27 of the character card 20, the stage card 50, and the event card 60, but in this case, the concept of a group (allies, episodes) may become ambiguous.

Therefore, in the present embodiment, the multi-leader card 40 is introduced, and the deck can be constructed from the character card 20, the stage card 50, and the event card 60 each of which includes different color information 27. That is, the deck (mixed color deck) can be constructed from the character card 20, the stage card 50, and the event card 60 each of which includes any one of “red”, “green”, “blue”, “purple”, “black”, and “yellow” which are pieces of color information 27 of all the groups.

However, in a case where all the character cards 20, the stage cards 50, and the event cards 60 can be elements of the mixed color deck, the concept of a group (allies, episodes) may become ambiguous. Therefore, in the present embodiment, the character card 20, the stage card 50, and the event card 60 that can be elements of the mixed color deck are limited. In this manner, the character card 20, the stage card 50, and the event card 60 that can be elements of the mixed color deck are described as a character card 20 compatible with the multi-leader card, a stage card 50 compatible with the multi-leader card, and an event card 60 compatible with the multi-leader card. Note that acquisition of the character card 20, the stage card 50, and the event card 60 which can be elements of the mixed color deck will be described later.

Note that, in the following description, in order to facilitate understanding of the present embodiment, first, a case where the leader card to be used by the user is the leader card 30 including the single color information 27 will be described.

The user selects the character cards 20, the stage cards 50, and the event cards 60 to which the same color information 27 is attached, and constructs a deck to be arranged in the deck area 31. The number of cards in the deck to be constructed is determined beforehand. In the following description, an example in which there are 50 cards in the deck will be described. The constructed deck is arranged in the deck area 31 in a state where the front faces of the cards face down.

The user selects one leader card 30 to which the same color information as the color information of the constructed deck is attached, and arranges the leader card 30 in the leader area 33 in a state where the front face of the leader card 30 faces up.

A predetermined number of cost cards 10 are arranged in the cost deck area 35. In the following description, an example in which ten cost cards are arranged will be described.

The user draws a predetermined number of game cards as the hand from the game cards arranged in the deck area 31. Here, it is assumed that five game cards 1 are drawn.

The user draws the game cards 1 arranged in the deck area 31 in accordance with the number described in the life information 28 of the leader card 30 arranged in the leader area 33, and arranges the game cards 1 in the life area 37 in a state where the front faces of the game cards 1 face down.

### Flow of Game

When the game is started, a first player and a second player are determined with the opponent, and turns are alternately repeated from the first player.

Each turn includes a plurality of phases such as a refresh phase, a draw phase, a cost phase, a main phase, and an end phase. In the following description, an example with five phases will be described for ease of explanation, but each turn may include any number of types of phases.

In the refresh phase, the game cards 1 arranged on the play field 2 (place) are set to an active state. In addition, the cost cards 10 arranged in the character area 32 and the leader area 33 are set to the active state and are returned to the cost area 36.

In the draw phase, one game card 1 is drawn from the deck area 31, and is added to the hand.

In the cost phase, two cost cards 10 are drawn from the cost deck area 35, are set to the active state, and are arranged in the cost area 36.

In the main phase, the player performs at least one of the following actions:
arrange a character card 20 from the hand in the character area 32,
arrange a stage card 50 from the hand in the stage area 34, and
put an event card 60 onto the play field 2. At this time, the character card 20, the stage card 50, and the event card 60, of which the value of the cost information 25 is equal to or smaller than the number of the cost cards 10 in the active state in the cost area 36, are arranged in the active state from the hand onto the play field 2.

Next, in the main phase, the effects of the stage card 50 and the event card 60 can be applied. The stage card 50 after application of the effect is set from the active state to a rest state. The event card 60 after application of the effect is moved to the out-of-game area 38.

Further, in the main phase, it is possible to apply power to the character card 20 and the leader card 30.

Subsequently, an attack is executed against the opponent. The user determines the game card 1 (attack card) to be used for an attack, from either the character cards 20 arranged in the character area 32 of the user's own area or the leader card 30 arranged in the leader area 33 of the user's own area. Next, a character card 20 arranged in the character area 32 of the opponent as the attack target or a leader card 30 (attack target card) arranged in the leader area 33 of the opponent is determined. Using the attack card, an attack is executed on the attack target card. The win/loss of the battle is determined depending on whether the numerical value of the power information 22 of the attack card is larger than the numerical value of the power information of the attack target card. In a case where the numerical value of the attack card is larger than the numerical value of the character card 20 as the attack target card, the battle is won.

In a case where the attack target card is a character card 20, and the numerical value of the power information 22 of the attack card is larger than the numerical value of the power information of the attack target card, the user has won in the battle in the user's turn. The attacked opponent arranges the attacked character card 20 in the out-of-game area 38.

In a case where the attack target card is a leader card 30, and the numerical value of the power information 22 of the attack card is larger than the numerical value of the power information 22 of the leader card 30 as the attack target, the user has won in the battle in the user's turn. The attacked opponent adds one game card arranged in the life area 37 to the hand. At this time, in a case where there is no game card to be added to the hand by the opponent in the life area 37, the user wins, and the game is ended.

In the end phase, the game cards 1 in the rest state on the play field 2 are switched to the active state, and the end phase is ended.

The above is the outline of the game according to the present embodiment.

Next, an overall configuration of a game system that realizes the above-described game will be described.

### Overall Configuration

FIG. 10 is a diagram illustrating an overall configuration example of a game system according to the present embodiment. As illustrated in FIG. 10, the game system includes player terminals 3 respectively prepared for players A and B of the game, and a game server 4. The player terminal 3 and the game server 4 can be connected to a communication line N, and can perform communication with each other.

The communication line N means a communication path through which data communication can be performed. That is, a communication line N includes a communication network such as a telephone communication network, a cable network, the Internet, or the like in addition to a LAN by a dedicated line (dedicated cable), Ethernet (registered trademark), or the like for direct connection, and the communication method may be wired or wireless.

The player terminal 3 is a computer capable of executing a game program, is connected to the communication line N via a wireless communication base station or the like, and can perform data communication with the game server 4. The player terminal 3 is, for example, a smartphone, a mobile phone, a portable gaming apparatus, a home gaming console, an arcade gaming apparatus, a personal computer, a tablet computer, a controller for a home gaming console, or the like. Basically, there are a plurality of player terminals 3, each of which is operated by a player.

The game server 4 is a server system including a single or a plurality of server apparatuses, a single or a plurality of storage apparatuses, and the like. The game server 4 can provide various services for operating the game according to the present embodiment, manage data required for operating the game, and distribute the game program and the data required for execution of the game on the player terminals 3.

### Configuration of Apparatus

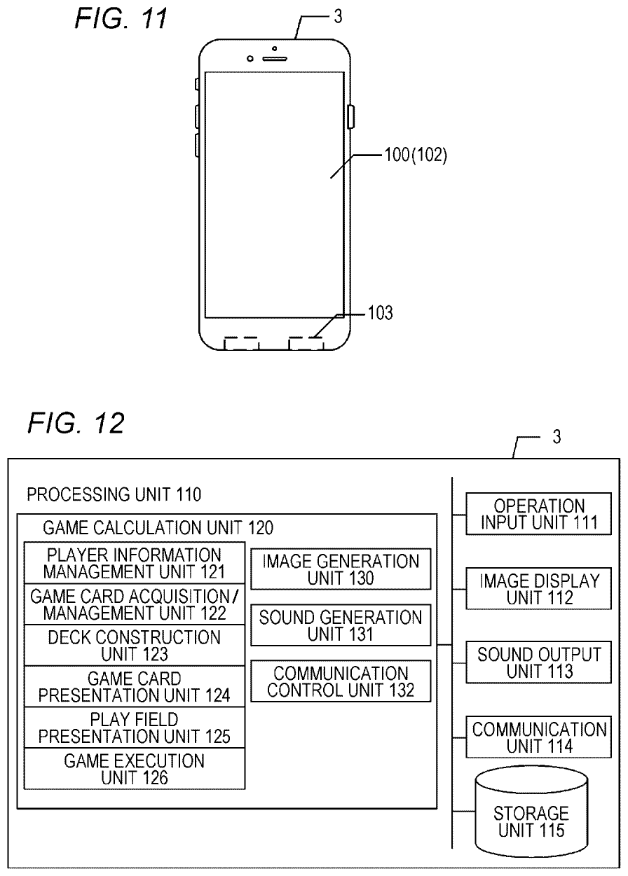

FIG. 11 is a diagram illustrating an apparatus configuration example of a smartphone that is an example of the player terminal 3. As illustrated in FIG. 11, the player terminal 3 includes a display 101, a touch operation panel 102 integrally formed with a display 101, and a speaker 103 provided in a housing. In addition, the player terminal 3 is provided with a control board, a built-in battery, a power button, a volume adjustment button, and the like that are not illustrated.

Various microprocessors such as a CPU, a GPU, and a DSP, an ASIC, various IC memories such as a VRAM, a RAM, and a ROM, a wireless communication module for performing wireless communication with a mobile phone base station, and the like are mounted on the control board. Further, a so-called I/F circuit (interface circuit) such as a driver circuit of the touch operation panel 102 is mounted on the control board. The elements mounted on the control board are electrically connected to each other via a bus circuit or the like, and are connected such that reading and writing of data and transmission and reception of signals can be performed.

FIG. 12 is a block diagram illustrating a functional configuration example of the player terminal 3.

As illustrated in FIG. 12, the player terminal 3 includes a processing unit 110, an operation input unit 111, an image display unit 112, a sound output unit 113, a communication unit 114, and a storage unit 115.

The processing unit 110 comprehensively controls an operation of the player terminal 3 based on programs and data stored in the storage unit 115, an operation input signal from the operation input unit 111, and the like. The function of the processing unit 110 can be implemented by, for example, a microprocessor such as a CPU or a GPU, and an electronic component such as an ASIC or an IC memory. The processing unit 110 includes a game calculation unit 120, an image generation unit 130, a sound generation unit 131, and a communication control unit 132 as main functional units.

The game calculation unit 120 executes various game processing for realizing the game according to the present embodiment, and outputs processing results to the image generation unit 130 and the sound generation unit 131. The game calculation unit 120 includes a player information management unit 121, a game card acquisition unit 122, a game card presentation unit 123, a deck construction unit 124, a game field presentation unit 125, and a game execution unit 126.

The player information management unit 121 manages player information. In the information management, basic user information such as a nickname of a player is managed.

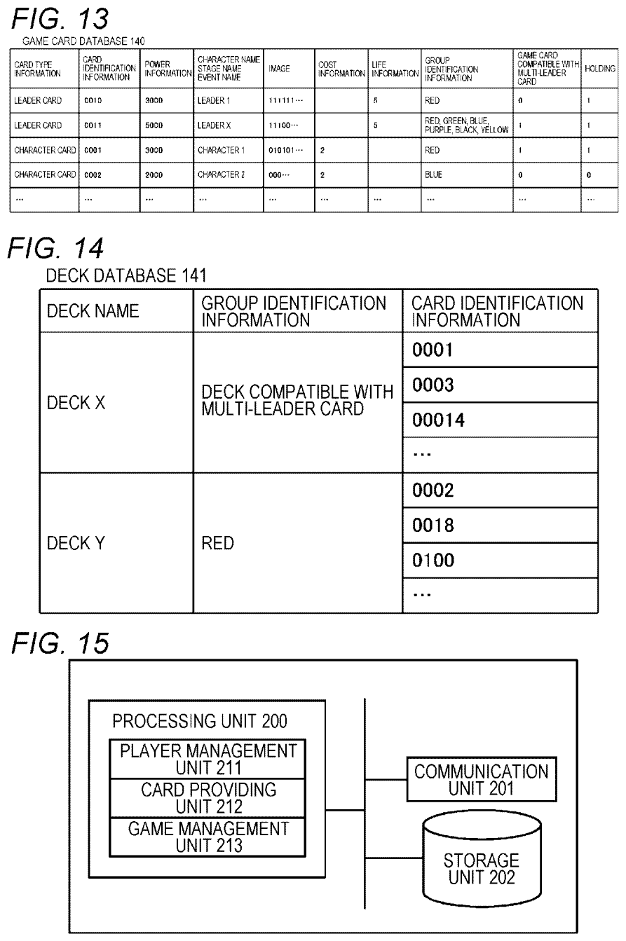

The game card acquisition/management unit 122 performs processing related to acquisition and management of the game card 1. The acquisition and management of the game card 1 are performed using a game card database 140. FIG. 13 is an example of the game card database 140. One record of the game card database 140 includes fields of card type information, card identification information, a character name/stage name/event name, image data, cost information, life information, group identification information, a multi-leader card compatibility flag, and a player holding flag. In the field of the card type information, the type of the card is described, and any one of a cost card, a leader card, a character card, a stage card, and an event card is described. In the field of the card identification information, a card number is described. In the field of the character name/stage name/event name, a character name, a stage name, or an event name associated with the card is described. In the field of the image data, image data of the card is included. In the field of the cost information, cost information of the card is described. In the field of the life information, life information of the card is described. In the field of the group identification information, the group identification information of the group to which the character, the stage, or the event associated with the card belongs is described. In the field of the game card compatible with the multi-leader card, information on whether or not the game card compatible with the multi-leader card can be a constituent element of the mixed color deck is described. As will be described later, “1” is described in a case where the game card compatible with the multi-leader card can be a constituent element of the mixed color deck, and “0” is described in a case where the game card compatible with the multi-leader card cannot be a constituent element of the mixed color deck. For the holding flag, “1” is described in a case where the game card 1 is held by the player, and “0” is described in a case where the game card 1 is not held by the player.

The game card database 140 is provided from the game server 4, another application distribution server, or the like in a case where the player completes account registration, and the information of the game card 1 is updated every time a new game card 1 is provided (sold).

The game card 1 is provided to the player in a case where a predetermined condition is satisfied. Examples of the predetermined condition include payment of a price (money, in-game money, points acquired by a player by participating in a lottery event performed on the Internet, and the like), exchange with rewards earned for player's actions inside or outside the game, registration of a user account, and the like. The game card acquisition/management unit 122 transmits a game card provision request to the game server 4, and in a case where a game card provision condition is satisfied, receives the card identification information and permission of the holding flag transmitted from the game server 4. In this case, the game card acquisition/management unit 122 sets the holding flag of the record of the card identification information of the game card 1 to “1”. Thereby, the player holds the game card 1.

As one method of providing the game cards 1, in the present embodiment, a predetermined pack in which a plurality of game cards 1 are packaged and each game card is a game card 1 including single color information 27 is provided. Each pack is not limited to the game cards 1 including the same color information 27, and includes the game cards 1 including different color information 27. A plurality of types of such packs are provided. The plurality of types of packs includes game cards 1 including different color information 27, and characters associated with the game cards 1 do not originally belong to the same group, but each character is a specific character (hereinafter, referred to as a specific character) having a relationship with other characters. Then, the game card 1 (the character card 20, the stage card 50, and the event card 60) of the specific character can construct a mixed color deck by using the multi-leader card 40. Hereinafter, the game card 1 (the character card 20, the stage card 50, and the event card 60) of the specific character that can construct a mixed color deck by using the multi-leader card 40 is referred to as a game card compatible with the multi-leader card.

Note that one multi-leader card 40 may be included in each pack. Also, a method of setting a pack including the multi-leader card 40 in advance and notifying the user that the pack includes the multi-leader card 40 may be used.

In a case where the game card compatible with the multi-leader card is acquired, the game card acquisition/management unit 122 sets the holding flag of the record of the card identification information of the game card 1 to “1”.

The game card presentation unit 123 presents the cost card 10, the character card 20, the leader card 30, the multi-leader card 40, the stage card 50, and the event card 60 as illustrated in FIG. 2 to FIG. 8 to the player terminal 3 by using the game card database 140.

The deck construction unit 124 constructs a deck to be used for the game from the game cards held by the player. As described above, the deck can be constructed from the character card 20, the stage card 50, and the event card 60.

In the game according to the present embodiment, as described above, unless the deck is constructed from the character card 20, the stage card 50, and the event card 60 each of which includes the same group identification information (color information 27) as the group identification information (color information 27) of the leader card 30 and the multi-leader card 40 to be used in the game, the deck cannot be used together with the leader card 30 and the multi-leader card 40. For example, in the example of FIG. 9, in a case where the leader card 30 including the group identification information (color information 27) of red is used in a game, the leader card can be used only in a deck constructed from the character card 20, the stage card 50, and the event card 60 each of which includes the group identification information (color information 27) of red. On the other hand, in a case where the multi-leader card 40 is used in a game, the multi-leader card 40 can be used only in a deck constructed from the character card 20, the stage card 50, and the event card 60 which are game cards compatible with the multi-leader card.

Therefore, in order to enhance the convenience of the player, when selecting the character card 20, the stage card 50, and the event card 60 for constructing a deck, the deck construction unit 124 displays a deck construction screen on which only the character card 20, the stage card 50, and the event card 60 according to the group identification information (color information 27) of the leader card to be used are displayed on the player terminal 3.

Further, the deck construction unit 124 manages the deck by using a deck database 141. FIG. 14 is a diagram illustrating an example of the deck database 141. In the deck database 141 of FIG. 14, a field of a deck name, a field of group identification information of a deck, and a field of card identification information of a game card for constructing the deck are stored in association with each other. Note that, in the field of the group identification information of the deck, color information (In the case of a plurality of groups, color information of each group) is described in the case of a single color deck, and a deck compatible with the multi-leader card is described in the case of a mixed color deck constructed from the game cards compatible with the multi-leader card.

In a case where a deck is newly constructed, the deck construction unit 124 writes the deck name and the card identification information of the game card for constructing the deck in the deck database 141, and updates the deck database 141.

The play field presentation unit 125 displays the play field 2 illustrated in FIG. 1 on the player terminal 3.

The game execution unit 126 arranges and moves the game card 1 according to the operation of the game card by the player. In addition, the game execution unit 126 performs attack, defense, effect application, and event application of each game card 1 by referring to the power information, the cost information, the life information, and the like (hereinafter, may be collectively referred to as character information) of each game card 1. The game execution unit 126 determines win/loss of the game, and manages progress of the entire game.

The image generation unit 130 generates one game screen in one frame time (for example, 1/60 seconds) based on the processing result of the game calculation unit 120, and outputs an image signal of the generated game screen to the image display unit 112. The function of the image generation unit 130 can be implemented by, for example, a processor such as a GPU or a digital signal processor (DSP), a program for a video signal IC, a video codec, and the like, an IC memory for a drawing frame such as a frame buffer, an IC memory used for developing texture data, and the like.

The sound generation unit 131 generates sound signals such as sound effects and BGM related to the game, audio information of operation assistance information, and various operation sounds based on the processing result of the game calculation unit 120, and outputs the sound signals to the sound output unit 113. The function of the sound generation unit 131 can be implemented by, for example, a processor such as a digital signal processor (DSP) or an audio synthesis IC, an audio codec capable of reproducing an audio file, or the like.

The communication control unit 132 performs communication connection and data processing for data communication with the game server 4.

The operation input unit 111 is for allowing the player to input various operations related to the game, and outputs an operation input signal corresponding to the operation input to the processing unit 110. The function of the operation input unit 112 can be implemented by, for example, not only an element directly operated by the player A with a finger, such as a touch operation pad, a home button, a button switch, a joystick, or a trackball, but also an element that detects motion or posture, such as an acceleration sensor, an angular velocity sensor, an inclination sensor, or a geomagnetic sensor. In FIG. 11, the touch operation panel 102 corresponds to the operation input unit.

The image display unit 112 displays various game screens based on the image signal input from the image generation unit 130. The function of the image display unit 112 can be implemented by, for example, a display apparatus such as a flat panel display, a projector, or a head mounted display. In the player terminal 3 of FIG. 11, the image display unit 112 corresponds to the display 101.

The sound output unit 113 is for outputting a sound effect or the like related to the game based on the sound signal input from the sound generation unit 131. In the player terminal 3 of FIG. 11, the sound output unit 131 corresponds to the speaker 103.

The communication unit 114 is connected to the communication line N and implements communication. The function of the communication unit 114 can be implemented by, for example, a wireless communication apparatus, a modem, a terminal adapter (TA), a jack of a wired communication cable, a control circuit, or the like.

In the storage unit 115, a program for operating the player terminal 3 and implementing the various functions of the player terminal 3, data used during execution of the program, and the like are stored in advance, or are temporarily stored each time processing is performed. The storage unit 115 can be implemented by, for example, an IC memory such as a RAM, a ROM, or a flash memory, a magnetic disk such as a hard disk, an optical disk such as a CD-ROM or a DVD, or the like.

The storage unit 115 stores a system program and a game program. The system program is a program for implementing a basic function of the player terminal 3 as a computer. The game program is a program causing the processing unit 110 to function as the game calculation unit 120. In a case where the player completes account registration, the program is distributed from the game server 4, another application distribution server, or the like.

In addition, the storage unit 115 stores the game card database 140 and the deck database 141 described above.

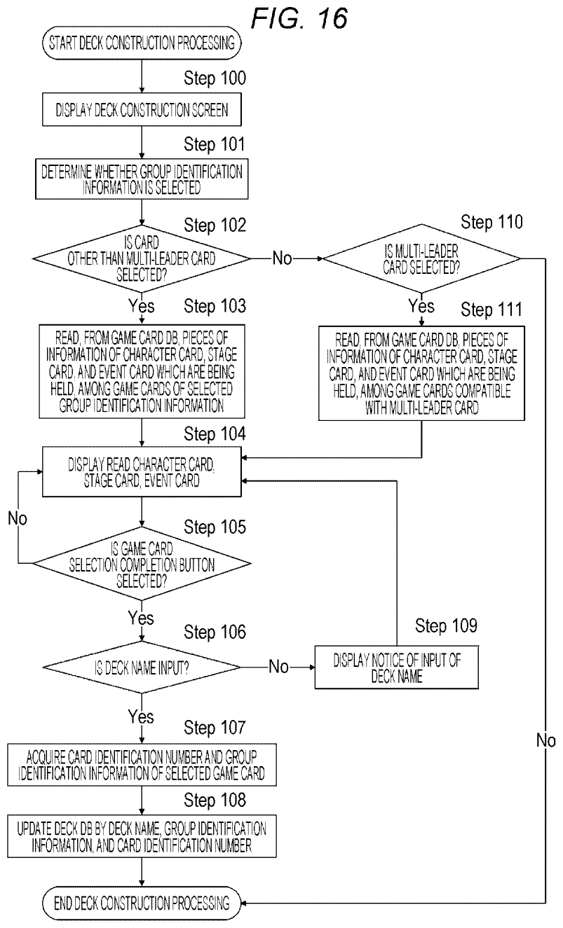

Next, a configuration of the game server 4 will be described. FIG. 15 is a block diagram illustrating a functional configuration example of the game server 4.

The game server 4 includes a processing unit 200, a communication unit 201, and a storage unit 202.

The processing unit 200 includes a player management unit 211, a card providing unit 212, and a game management unit 213.

The player management unit 211 manages an account, a progress status of a game, and the like for each player of the player terminal 3 by using the user information data. In addition, management for each player is managed by a database similar to the game card database 140 prepared for each player. In addition, in a case where it is necessary to update the game card database 140 such as addition of a new game card 1, the game card database 140 of the terminal 3 of each player is updated.

The card providing unit 212 is a unit that provides a card to a player, and provides a function called a shop. Specifically, in response to a provision request of the game card 1 from the terminal 3 of the player, the card providing unit 212 transmits a provision screen (for example, a top screen of the shop) to the terminal 3.

As a method in which the card providing unit 212 provides cards as a shop, there are (1) a method of providing only a desired game card 1 and (2) a method of providing a package of a plurality of game cards 1 (a collection of a plurality of game cards 1 of a series). The method of (2) is, for example, a package including a plurality of game cards compatible with the multi-leader card described above. The storage unit 202 stores an acquisition probability of each card, card identification information of the card included in each package, an acquisition price of each card, and the like, and the card providing unit 212 provides the card identification information of the card to be provided to the player terminal 3 by using these pieces of information. In addition, the card providing unit 212 also performs payment of a price (cash, in-game money, ticket) for acquiring the card.

The game management unit 213 manages the entire game including matching between a player and an opponent player.

The communication unit 201 is connected to the communication line N and implements communication.

The storage unit 202 stores a system program and a game program. The system program is a program for implementing a basic function of the game server 4 as a computer. The game program is a program causing the processing unit 200 to function as the player management unit 211, the card providing unit 212, and the game management unit 213. Further, the storage unit 202 stores various data described above.

Next, an operation according to the present embodiment will be described.

First, an operation of constructing a deck to be used in a game will be described.

### Operation of Deck Construction Processing

An operation of deck construction processing by the deck construction unit 124 will be described. FIG. 16 is an operation flowchart of deck construction processing.

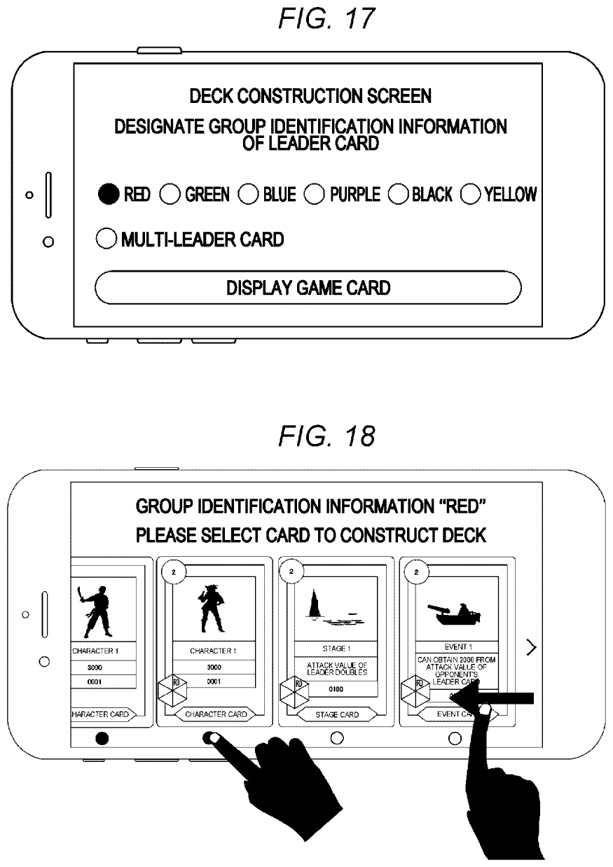

In a case where a deck construction screen is selected from a menu screen of the game, the deck construction unit 124 displays a deck construction screen (Step 100). FIG. 17 is an example of a deck construction screen displayed by the deck construction unit 124. On the deck construction screen of FIG. 17, the user can select any one of red, green, blue, purple, black, and yellow, which are group identification information (color information 27) of the leader card to be used, and colors (all colors) of the multi-leader card. Note that a plurality of pieces of color information may be simultaneously selected.

The deck construction unit 124 determines whether group identification information (color information 27) is selected by the user (Step 101). In a case where the selection of the group identification information (color information 27) by the user is a card other than the multi-leader card (Step 102), the deck construction unit 124 reads information (the character information, the image) of the character card 20, the stage card 50, and the event card 60 each of which includes the selected group identification information (color information 27) and which are held by the player (holding flag is “1”) among the game cards registered in the game card database 140 (Step 103). In the example of the deck construction screen of FIG. 17, since red is selected by the user, the deck construction unit 124 reads information (the card identification number, the character information, and the image) of the character card 20, the stage card 50, and the event card 60 each of which includes the group identification information (color information 27) of red and includes the holding flag of “1”, from the game card database 140.

The deck construction unit 124 displays the character card 20, the stage card 50, and the event card 60 each of which includes the selected group identification information (color information 27), from the read information (Step 104). FIG. 18 is a diagram illustrating an example of display of a game card including the selected group identification information (color information 27). In the example of FIG. 18, the character card 20, the stage card 50, and the event card 60 each of which includes the group identification information (color information 27) of red are displayed. Then, in a case where the player scrolls the screen, another character card 20, another stage card 50, and another event card 60 can be displayed. Further, a selection button for selecting a game card to be a constituent element of a deck is provided below each game card, and the player can select the character card 20, the stage card 50, or the event card 60 displayed above the selection button as a game card to be a constituent element of a deck by selecting the selection button.

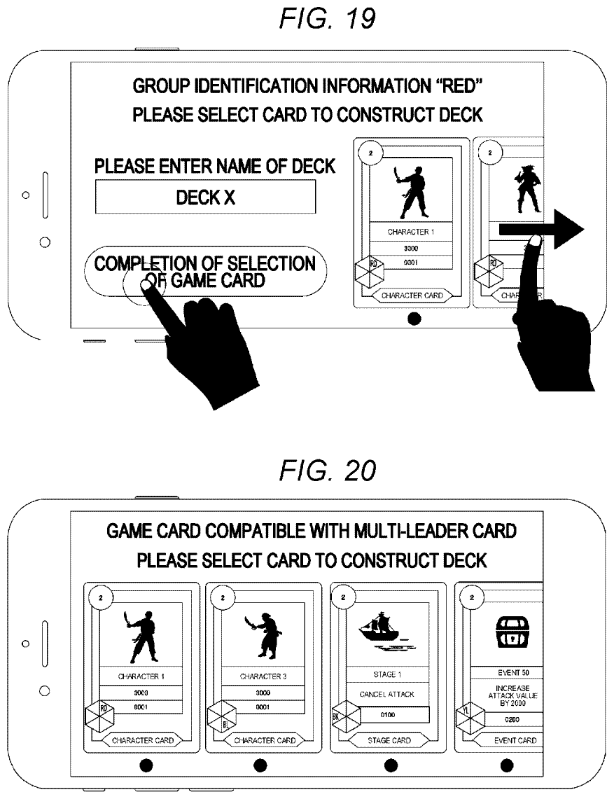

In a case where the selection of the game card for constructing a deck is completed, the player scrolls the screen to display a game card selection completion button as illustrated in FIG. 19, inputs a deck name, and selects the game card selection completion button.

The deck construction unit 124 determines whether the game card selection completion button is selected (Step 105). In a case where the game card selection completion button is selected, the deck construction unit 124 determines whether a deck name is input (Step 106). In a case where a deck name is not input, warning display for inputting a deck name is performed (Step 109), and the process returns to Step 104.

In a case where the game card selection completion button is selected and a deck name is input, the deck construction unit 124 acquires the card identification number and the group identification information of the selected character card 20, the selected stage card 50, or the selected event card 60 (Step 107).

The deck construction unit 124 registers the deck name, the group identification information of the deck, and the acquired game card identification number in the deck database 141, and updates the deck database 141 (Step 108). Thereby, the player can newly construct and register a deck. The deck constructed in this way is a monochromatic deck.

On the other hand, in a case where the selection of the group identification information (color information 27) by the user is the multi-leader card (Step 110), the deck construction unit 124 reads information (the character information, the image) of the character card 20, the stage card 50, and the event card 60 which are game cards compatible with the multi-leader card (the flag of the game card compatible with the multi-leader card is “1”) and are held by the player (the holding flag is “1”) among the game cards registered in the game card database 140 (Step 111).

The deck construction unit 124 displays the character card 20, the stage card 50, and the event card 60 which are compatible with the multi-leader card, from the read information (Step 104). FIG. 20 is a diagram illustrating an example of display of a game card compatible with a multi-leader card. In the example of FIG. 20, the character card 20, the stage card 50, and the event card 60 each of which includes different group identification information (color information 27) but can be used in a game together with the multi-leader card 40 are displayed. Then, in a case where the player scrolls the screen, another character card 20, another stage card 50, and another event card 60 can be displayed. Further, a selection button for selecting a game card to be a constituent element of a deck is provided below each game card, and the player can select the character card 20, the stage card 50, or the event card 60 displayed above the selection button as a game card to be a constituent element of a deck by selecting the selection button.

After the character card 20, the stage card 50, or the event card 60 each of which is compatible with a multi-leader card is displayed, the deck construction unit 124 proceeds to Step 105 and performs similar processing. Thereby, the player can newly construct and register a deck. The deck constructed in this way is a mixed color deck. Note that, in the case of a deck compatible with a multi-leader card, the group identification information to be registered in the deck database 141 indicates that the deck is compatible with a multi-leader card.

### Operation of Play Field Presentation Processing

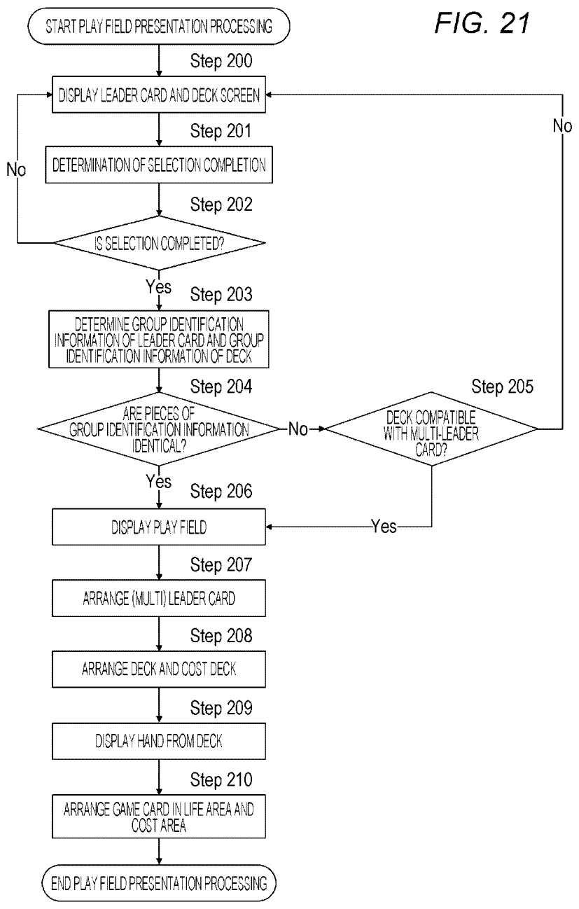

Next, play field presentation processing will be described. FIG. 21 is an operation flowchart of play field presentation processing.

Prior to a battle of a game, the player selects a leader card 30 or a multi-leader card 40, and a deck to be used in the game.

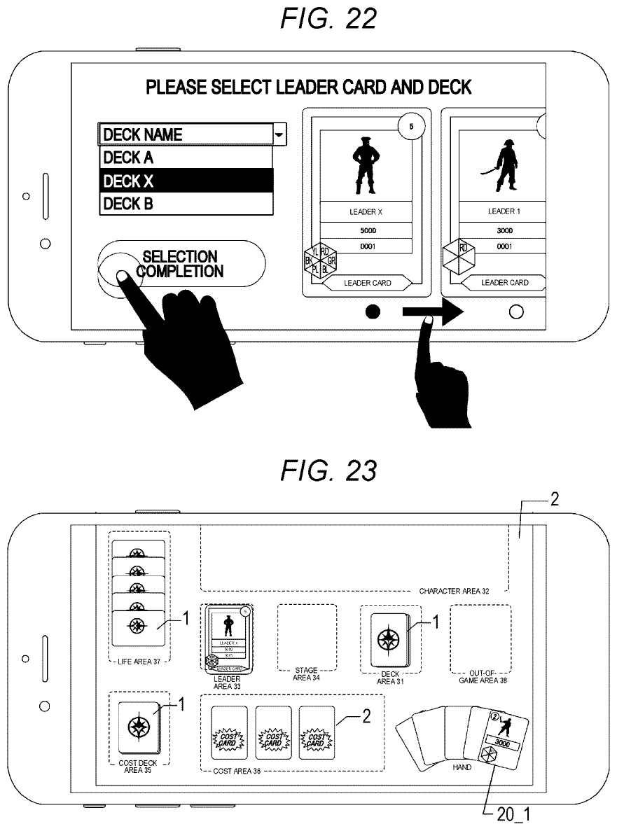

The game execution unit 126 displays a screen for selecting a leader card and a deck on the terminal 3 of the player (Step 200). The game execution unit 126 reads information of the leader card 30 or the multi-leader card 40 held by the player from the game card database 140, and reads the name of the deck registered by the player from the deck database 141. Then, a screen for selecting a leader card and a deck is displayed from the read information. FIG. 22 is a diagram illustrating an example of a screen for selecting a leader card and a deck. In FIG. 22, on the screen for selecting a leader card and a deck, the leader card 30 or the multi-leader card 40 held by the player is displayed, and a selection button is displayed below each card. Further, the deck registered by the player can be selected. Then, in a case where selection of the leader card 30 or the multi-leader card 40 and the deck is completed, the completion button is selected, and selection of the leader card and the deck to be used in the game is completed.

The game execution unit 126 determines that selection of the leader card and the deck is completed (Step 201). In a case where the selection completion button for the leader card and the deck is selected (Step 202), the game execution unit 126 determines the group identification information (color information 27) of the selected leader card and the group identification information (color information 27) of the selected deck (Step 203).

The game execution unit 126 reads the group identification information (color information 27) of the selected leader card from the game card database 141, and reads the group identification information (color information 27) of the selected deck from the deck database 141. Then, comparison between the group identification information (color information 27) of the leader card and the group identification information (color information 27) of the deck is performed.

In a case where the group identification information (the color information 27) of the selected leader card and the group identification information (the color information 27) of the selected deck are identical (Step 204), the game execution unit 126 instructs the play field presentation unit 125 to present the play field. On the other hand, in a case where the group identification information (color information 27) of the selected leader card and the group identification information (color information 27) of the selected deck are not identical (Step 204), the game execution unit 126 determines whether the selected leader card is a multi-leader card and whether the group identification information (color information 27) of the selected deck is group identification information of a deck compatible with a multi-leader card (Step 205). In a case where the selected leader card is a multi-leader card and the group identification information (color information 27) of the selected deck is a deck compatible with a multi-leader card, the game execution unit 126 instructs the play field presentation unit 125 to present the play field.

The play field presentation unit 125 displays the play field on the terminal 3 of the player (Step 206). Then, the play field presentation unit 125 arranges the selected leader card 30 or the selected multi-leader card 40 in the leader area 33 of the play field (Step 207). The play field presentation unit 125 arranges the deck in the deck area 31, and arranges the cost deck (the deck of the cost card 35) in the cost area deck 35 (Step 208). The play field presentation unit 125 displays a predetermined number of game cards as the hand from the deck (Step 209). The play field presentation unit 125 arranges the number of pieces of the life information of the leader card 30 or the multi-leader card 40 from the deck into the life area 37, and arranges the predetermined number (for example, 3 pieces) of the cost cards 10 from the cost deck into the cost area 36 (Step 210).

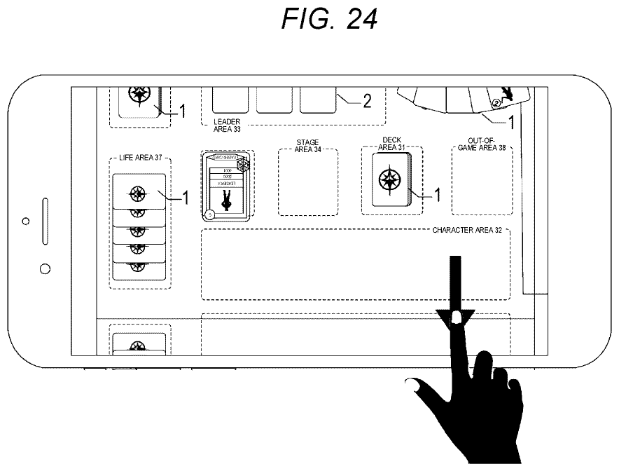

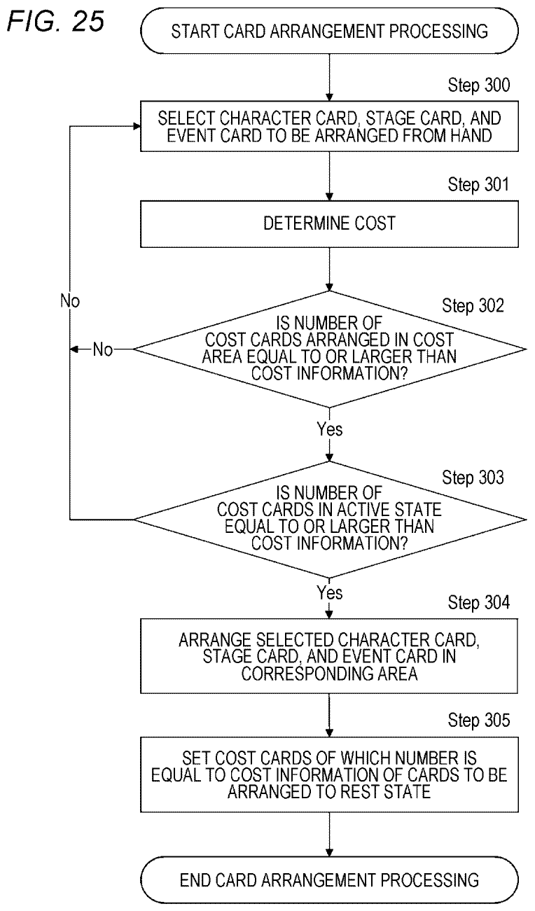

FIG. 23 and FIG. 24 are diagrams illustrating an example of a play field 2 displayed on the player terminal 3. The example illustrated in FIG. 23 is an example of a state in which the multi-leader card 40 selected by the player is arranged in the leader card area 33, and the hand, the deck, the cost card, and the like are arranged in each area. As illustrated in FIG. 24, the player can also confirm the play field of the opponent player by sliding down the play field.

In this way, arrangement of the play field and each game card is completed, and preparation for the game is completed.

### Operation of Card Arrangement Processing

An operation of processing of arrangement (appearance) of the character card 20, the stage card 50, and the event card 60 on the game fields will be described. FIG. 25 is a flowchart of card arrangement processing.

The player selects the character card 20, the stage card 50, and the event card 60 to be arranged (appeared) on the game fields from the hand (Step 300).

The game execution unit 126 determines the cost of the selected card (Step 301). The game execution unit 126 counts the number of the cost cards 10 arranged in the cost area 36, and determines whether cost cards 10 of which the number is equal to or larger than the cost information of the selected card are arranged in the cost area 36 (Step 302). In a case where the cost cards 10 of which the number is equal to or larger than the cost information of the selected card are arranged in the cost area 36, the game execution unit 126 determines whether the number of the cost cards 10 in the active state among the cost cards 10 arranged in the cost area 36 is equal to or larger than the cost information of the selected card (Step 303).

In a case where the number of the cost cards 10 in the active state is equal to or larger than the cost information of the selected card, the game execution unit 126 arranges the selected card in the corresponding area (Step 304).

The game execution unit 126 changes the states of the cost cards 10 of which the number is equal to the cost information of the arranged card, from the active state to the rest state (Step 305).

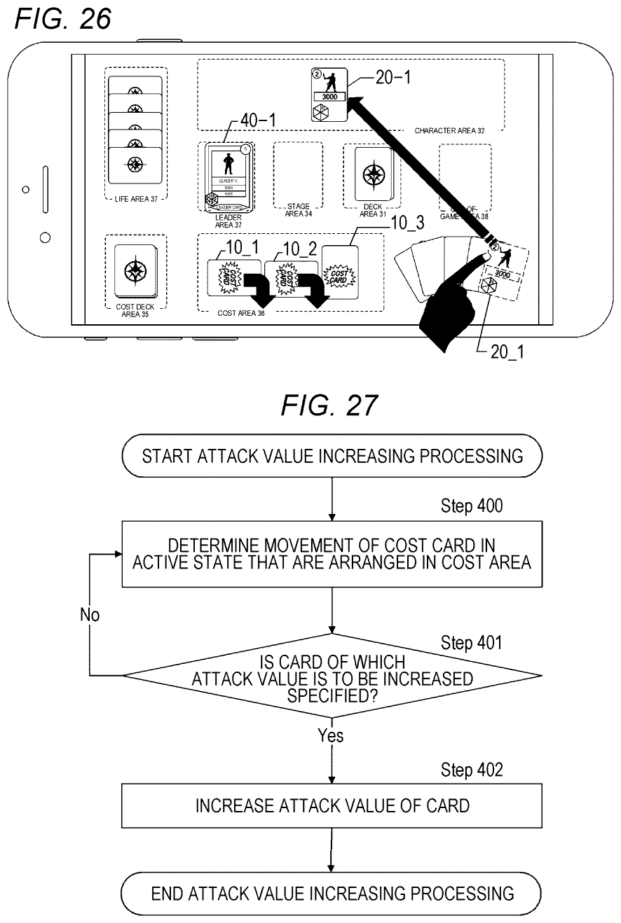

FIG. 26 is a diagram for explaining an operation of arranging a card. In the example of FIG. 26, an example in which the hand is arranged on the play field 2 in the main phase and a cost is further applied to the character card 20 is described. This processing is described using an example in which, as illustrated in FIG. 26, a character card 20 1 is in the hand and the following cards are arranged on the play field 2:
one leader card 30 is arranged in the leader area 37; and
three cost cards 10_1 to 10_3 in the active state are arranged in the cost area 36.

In order to arrange a character card 20_1 of which the cost information 25 in the hand is “2” and the attack value information 25 is “3000” in the character area 32 in the main phase, the player touches the character card 20_1 and drags the character card to the character area 32.

Here, since the cost information 25 of the character card 20_1 is “2”, the game execution unit 126 sets two of the three cost cards 10 in the active state that are arranged in the cost area 36 to the rest state, and arranges the character card 20_1 in the character area 32.

In this manner, the character card 20, the stage card 50, and the event card 60 are arranged in the game fields.

### Operation of Processing of Increasing Attack Value of Card

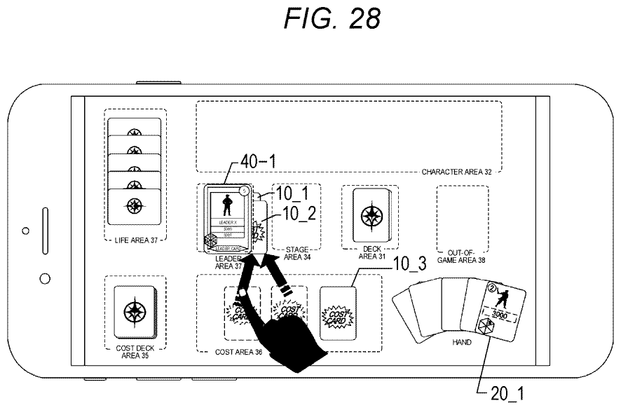

An operation of processing of increasing the power information (attack value) of the character card 20, the stage card 50, and the event card 60 will be described. FIG. 27 is a flowchart of attack value increasing processing.

The cost card 10 in the active state that is arranged in the cost area is moved to a card (a character card 20, a stage card 50, and an event card 60) of which the attack value is desired to be increased (Step 400).

In a case where a card (a character card 20, a stage card 50, and an event card 60) of which the attack value is desired to be increased is specified (Step 401), the game execution unit 126 increases the attack value of the card (Step 402).

FIG. 28 is a diagram for explaining attack value increasing processing. In FIG. 28, an example in which a plurality of powers are applied to the multi-leader card 40 will be described. This processing is described using an example in which, as illustrated in FIG. 28, a character card 20_1 is in the hand and the following cards are arranged on the play field 2:
one multi-leader card 40 is arranged in the leader area 37; and
three cost cards 10_1 to 10_3 in the active state are arranged in the cost area 36.

In the main phase, the player applies two costs to the multi-leader card 40_1. In the play at this time, as illustrated in FIG. 28, the cost cards 10_1 and 10_2 in the active state are dragged (moved) to the multi-leader card 40_1. Thereby, the game execution unit 126 can specify the multi-leader card 40_1 whose attack value is to be increased.

Since the increase in the attack value increases the attack value by 1000 for one cost card 10, the game execution unit 126 increases the attack value of the multi-leader card 40_1 arranged on the cost cards 10_1 and 10_2 from 5000 to 7000.

Note that, in the above description, the power information 22 has been explained as an attack value against the opponent. However, the power information 22 may be at least either the attack value or a defense value of the user's game card 1 against the opponent's attack. In this manner, the variation of battle content widens, and the amusement of the game is enhanced.

According to the present embodiment, a cost card 10 is designed to have the function of increasing the attack value of the game card combined with the cost card 10 as the second function. Thereby, the game progresses in a variety of ways depending on the combination of the game cards, and thus, the amusement of the game is enhanced.

In the present embodiment, the concept of the group identification information is introduced into the game card, and thus, players can enjoy a game having a storyline. On the other hand, by providing a multi-leader card including the group identification information of all groups, it is also possible to cope with a case where a player owns a small number of game cards or where related characters are used simultaneously beyond the concept of a group.

Some or all of the above-described embodiments may also be described as in the following appendixes, but are not limited to the following description.

### Appendix 1

A Program Causing a Computer to Function As:
game element presentation means for presenting a first-type game element and a second-type game element, the first-type game element being associated with a first-type character and including a plurality of pieces of group identification information which are visually identifiable, and the second-type game element being associated with a second-type character and including any one piece of group identification information which is visually identifiable and is included in the plurality of pieces of group identification information; and
deck construction means for constructing a deck from the second-type game elements including any piece of group identification information included in the plurality of pieces of group identification information of the first-type game element.

### Appendix 2

The program according to Appendix 1, in which
the first-type game element includes pieces of group identification information of all groups to which the second-type characters belong.

### Appendix 3

The program according to Appendix 1 or Appendix 2, in which
the game element presentation means presents a third-type game element associated with the first-type character and including any one or two pieces of group identification information which are visually identifiable and are included in the plurality of pieces of group identification information, and
the deck construction means constructs a deck from the second-type game elements including the same group identification information as the group identification information of the third-type game element.

### Appendix 4

The program according to any one of Appendixes 1 to 3, in which
the game element presentation means displays the group identification information at the same position of the first-type game element, the second-type game element, and the third-type game element.

### Appendix 5

The program according to any one of Appendixes 1 to 4, in which
the group identification information is color information.

### Appendix 6

The program according to any one of Appendixes 1 to 5, in which
the game element presentation means displays a plurality of types of color information, which are adjacent to each other, on the first-type game element.

### Appendix 7

The program according to any one of Appendixes 1 to 6, in which
the deck construction means includes:
second-type game element presentation means for presenting the second-type game elements including the group identification information selected by a user among the second-type game elements held by the user;
selection means for selecting the second-type game elements for constructing a deck from the presented second-type game elements including the same group identification information; and
construction means for constructing a deck from the selected second-type game elements.

### Appendix 8

The program according to any one of Appendixes 1 to 7, in which
the deck construction means includes:
second-type game element presentation means for presenting the second-type game elements that are available in a case where the first-type game element is used in a game among the second-type game elements held by the user;
selection means for selecting the second-type game elements for constructing a deck from the presented second-type game elements; and
construction means for constructing a deck from the selected second-type game elements.

### Appendix 9

The program according to any one of Appendixes 1 to 8, in which
the program causes the computer to further function as:
acquisition means for acquiring a collection including a plurality of second-type game elements which are available in a case where the first-type game element is used in a game.

### Appendix 10

The program according to any one of Appendixes 1 to 9, in which
the presentation means presents a fourth-type game element which does not include the group identification information, and
the program causes the computer to further function as game element arrangement means for arranging the second-type game elements onto a game place in exchange for the presented fourth-type game element.

### Appendix 11

The program according to any one of Appendixes 1 to 10, in which
the program causes the computer to further function as:
game execution means for increasing attack power of the second-type game element in exchange for the presented fourth-type game element.

### Appendix 12

The program according to any one of Appendixes 1 to 11, in which
the program causes the computer to further function as play field presentation means for presenting a play field serving as a game place, and
the play field includes a first area in which the first-type game element or the third-type game element is arranged, a second area in which the second-type game element is arranged, and a third area in which the fourth-type game element is arranged.

### Appendix 13

The program according to any one of Appendixes 1 to 12, in which
the presentation means presents the first-type game element, the second-type game element, the third-type game element, and the fourth-type game element in a form of a card shape.

### Appendix 14

A terminal including:
game element presentation means for presenting a first-type game element and a second-type game element, the first-type game element being associated with a first-type character and including a plurality of pieces of group identification information which are visually identifiable, and the second-type game element being associated with a second-type character and including any one piece of group identification information which is visually identifiable and is included in the plurality of pieces of group identification information; and
deck construction means for constructing a deck from the second-type game elements including any piece of group identification information included in the plurality of pieces of group identification information of the first-type game element.

### Appendix 15

A game execution method causing a computer to execute:
presenting a first-type game element that is associated with a first-type character and includes a plurality of pieces of group identification information which are visually identifiable;
presenting a second-type game element that is associated with a second-type character and includes any one piece of group identification information which is visually identifiable and is included in the plurality of pieces of group identification information; and
constructing a deck from the second-type game elements including any piece of group identification information included in the plurality of pieces of group identification information of the first-type game element.

Although the present disclosure has been described above with reference to the preferred embodiments, the present disclosure is not necessarily limited to the above-described embodiments, and various modifications and implementations can be made within the scope of the technical idea.

1. A non-transitory computer-readable medium storing a program for causing a computer to execute processing of:
presenting a first-type game element and a second-type game element, the first-type game element being associated with a first-type character and including a plurality of pieces of group identification information which are visually identifiable, and the second-type game element being associated with a second-type character and including any one piece of group identification information which is visually identifiable and is included in the plurality of pieces of group identification information; and
constructing a deck from the second-type game elements including any piece of group identification information included in the plurality of pieces of group identification information of the first-type game element.

2. The non-transitory computer-readable medium storing the program according to claim 1, wherein
the first-type game element includes pieces of group identification information of all groups to which the second-type characters belong.

3. The non-transitory computer-readable medium storing the program according to claim 2, wherein the program causes the computer to execute processing of:
presenting a third-type game element associated with the first-type character and including any one or two pieces of group identification information which are visually identifiable and are included in the plurality of pieces of group identification information, and
constructing a deck from the second-type game elements including the same group identification information as the group identification information of the third-type game element.

4. The non-transitory computer-readable medium storing the program according to claim 3, wherein the program causes the computer to execute processing of:
displaying the group identification information at the same position of the first-type game element, the second-type game element, and the third-type game element.

5. The non-transitory computer-readable medium storing the program according to claim 4, wherein
the group identification information is color information.

6. The non-transitory computer-readable medium storing the program according to claim 5, wherein the program causes the computer to execute processing of:
displaying a plurality of types of color information, which are adjacent to each other, on the first-type game element.

7. The non-transitory computer-readable medium storing the program according to claim 3, wherein the program causes the computer to execute processing of:
presenting the second-type game elements including the group identification information selected by a user among the second-type game elements held by the user;
selecting the second-type game elements for constructing a deck from the presented second-type game elements including the same group identification information; and
constructing a deck from the selected second-type game elements.

8. The non-transitory computer-readable medium storing the program according to claim 7, wherein the program causes the computer to execute processing of:
presenting the second-type game elements that are available in a case where the first-type game element is used in a game among the second-type game elements held by the user;
selecting the second-type game elements for constructing a deck from the presented second-type game elements; and
constructing a deck from the selected second-type game elements.

9. The non-transitory computer-readable medium storing the program according to claim 8, wherein the program causes the computer to execute processing of:
acquiring a collection including a plurality of second-type game elements which are available in a case where the first-type game element is used in a game.

10. The non-transitory computer-readable medium storing the program according to claim 8, wherein the program causes the computer to execute processing of:
presenting a fourth-type game element which does not include the group identification information, and
arranging the second-type game elements onto a game place in exchange for the presented fourth-type game element.

11. The non-transitory computer-readable medium storing the program according to claim 10, wherein the program causes the computer to execute processing of:
increasing attack power of the second-type game element in exchange for the presented fourth-type game element.

12. The non-transitory computer-readable medium storing the program according to claim 11, wherein the program causes the computer to execute processing of:
presenting a play field serving as the game place, and
the play field includes a first area in which the first-type game element or the third-type game element is arranged, a second area in which the second-type game element is arranged, and a third area in which the fourth-type game element is arranged.

13. The non-transitory computer-readable medium storing the program according to claim 10, wherein the program causes the computer to execute processing of:
presenting the first-type game element, the second-type game element, the third-type game element, and the fourth-type game element in a form of a card shape.

14. A terminal comprising:
game element presentation for presenting a first-type game element and a second-type game element, the first-type game element being associated with a first-type character and including a plurality of pieces of group identification information which are visually identifiable, and the second-type game element being associated with a second-type character and including any one piece of group identification information which is visually identifiable and is included in the plurality of pieces of group identification information; and
deck construction means for constructing a deck from the second-type game elements including any piece of group identification information included in the plurality of pieces of group identification information of the first-type game element.

15. A game execution method comprising:
presenting a first-type game element that is associated with a first-type character and includes a plurality of pieces of group identification information which are visually identifiable;
presenting a second-type game element that is associated with a second-type character and includes any one piece of group identification information which is visually identifiable and is included in the plurality of pieces of group identification information; and
constructing a deck from the second-type game elements including any piece of group identification information included in the plurality of pieces of group identification information of the first-type game element.
